(19) United States
(12) Patent Application Publication
(10) Pub. No.: US 2023/0245508 A1
(43) Pub. Date: Aug. 3, 2023

(54) Sensing Assembly Having a Multiplexer

(71) Applicant: TE Connectivity Services GmbH, Schaffhausen (CH)

(72) Inventors: David Bruce Sarraf, Middletown, PA (US); William Russell, Middletown, PA (US)

(73) Assignee: TE Connectivity Services GmbH, Schaffhausen (CH)

(21) Appl. No.: 17/591,255

(22) Filed: Feb. 2, 2022

(51) Int. Cl. G07C 5/08

(52) U.S. Cl. CPC G07C 5/0808

(57) ABSTRACT

A sensing assembly includes a plurality of sensors and a multiplexer having a plurality of input channels and a multiplexer output channel. The plurality of input channels include a plurality of sensor input channels each connected to one of the sensors and a plurality of framing input channels. The multiplexer outputs an output sequence of a series of individual values received at the input channels at the multiplexer output channel. The output sequence has a plurality of sensor values received from the sensors between a framing start value and a framing end value received at the framing input channels.

### FIELD OF THE INVENTION

The present invention relates to a sensing assembly and, more particularly, to a sensing assembly reading values from a plurality of sensors.

### BACKGROUND

Modern technological advancements in many applications require the increased deployment and usage of sensors. Higher-level safety standards for charging electrical vehicles, for example, require more temperature sensors per contact pin of a vehicle charging inlet to increase confidence that any faults in the system are detected.

Although the increased deployment and usage of sensors enables advancements in control, convenience, safety, and many other areas, the larger number of sensors must be read by a control unit in order to execute these functions. Existing, cost-effective control units, however, have a limited number of input pins. Consequently, as the number of required sensors in an application increases, a more advanced and more expensive control unit is required with input pins for each sensor. A costly re-design and re-tooling of the structural elements of the application, for example the vehicle charging inlet, is often necessary to accommodate the more advanced control unit.

### SUMMARY

A sensing assembly includes a plurality of sensors and a multiplexer having a plurality of input channels and a multiplexer output channel. The plurality of input channels include a plurality of sensor input channels each connected to one of the sensors and a plurality of framing input channels. The multiplexer outputs an output sequence of a series of individual values received at the input channels at the multiplexer output channel. The output sequence has a plurality of sensor values received from the sensors between a framing start value and a framing end value received at the framing input channels.

### BRIEF DESCRIPTION OF THE DRAWINGS

The invention will now be described by way of example with reference to the accompanying Figures, of which:

FIG. 1 is a schematic block diagram of a sensing assembly according to an embodiment;

FIG. 2 is a flowchart of a process of using the sensing assembly of FIG. 1 to transmit data from a plurality of sensors to an ECU;

FIG. 3 is a graph of an output sequence of the sensing assembly of FIG. 1;

FIG. 4 is a flowchart of a fault checking process of the sensing assembly of FIG. 1;

FIG. 5 is a schematic block diagram of a sensing assembly according to another embodiment; and

FIG. 6 is a flowchart of a beginning of a process of using the sensing assembly of FIG. 5 to transmit data from a plurality of sensors to an ECU.

### DETAILED DESCRIPTION OF THE EMBODIMENT(S)

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. In addition, in the following detailed description, for purposes of explanation, numerous specific details are set forth to provide a thorough understanding of the disclosed embodiments. However, it is apparent that one or more embodiments may also be implemented without these specific details.

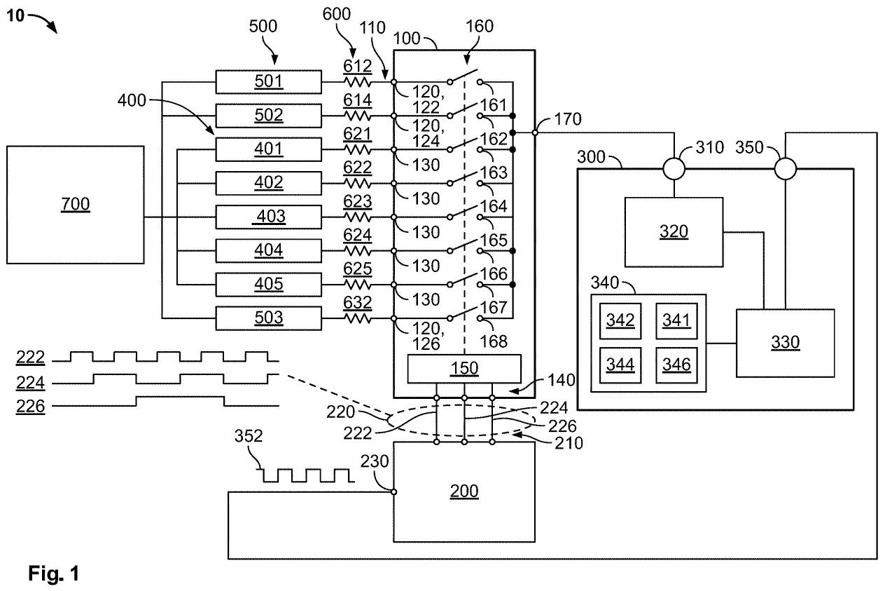

A sensing assembly 10 according to an embodiment is shown in FIG. 1. The sensing assembly 10 includes a multiplexer 100, a counter 200 connected to the multiplexer 100, an electronic control unit (ECU) 300 connected to the multiplexer 100 and the counter 200, a plurality of sensors 400 connected to the multiplexer 100, a plurality of framing devices 500 connected to the multiplexer 100, and a voltage source 600.

The multiplexer 100, as shown in FIG. 1, has a plurality of input channels 110, a plurality of control inputs 140, a decoder 150 connected to the control inputs 140, a plurality of switches 160 connected to the input channels 110 and the decoder 150, and a multiplexer output channel 170.

The input channels 110 are a plurality of inputs that receive signals at the multiplexer 100 and include a plurality of framing input channels 120 and a plurality of sensor input channels 130, as shown in FIG. 1. In an embodiment, the input channels 110 can be electrical pins, electrical pads, or any other conductive elements of the multiplexer 100. In the shown embodiment, the multiplexer has eight input channels 110, with three framing input channels 120 including a first framing input channel 122, a second framing input channel 124, and a third framing input channel 126, and five sensor input channels 130. In other embodiments, the multiplexer 100 may have less than eight or nine or more input channels 110, including at least two framing input channels 120 and any number of sensor input channels 130.

The control inputs 140 are a plurality of inputs that receive binary signals at the multiplexer 100. In an embodiment, the control inputs 140 can be electrical pins, electrical pads, or any other conductive elements of the multiplexer 100. In the embodiment shown in FIG. 1, the control inputs 140 are three inputs that receive signals from the counter 200, as described in greater detail below. The decoder 150 connected to the control inputs 140 may be any type of electronic decoder that is capable of converting the binary signals received at the control inputs 140 into a unique output.

The switches 160, as shown in FIG. 1, are each associated with one of the input channels 110; the number of switches 160 in the multiplexer 100 is equal to the number of input channels 110 in the multiplexer 100. In the shown embodiment, the multiplexer 100 has eight switches 160, including a first switch 161, a second switch 162, a third switch 163, a fourth switch 164, a fifth switch 165, a sixth switch 166, a seventh switch 167, and an eighth switch 168. In other embodiments, the number of switches 160 could be less than eight or nine or more, depending on the number of input channels 110 in the application. In the shown embodiment, each of the switches 160 is a single pole, single throw electrical switch.

The switches 160 connect the input channels 110 to the multiplexer output channel 170. The multiplexer 100 has a single multiplexer output channel 170, as shown in FIG. 1, through which the multiple signals received at the input channels 110 can be transmitted in a sequence determined by the closing of the switches 160. The multiplexer output channel 170 can be an electrical pin, an electrical pad, or any other conductive element of the multiplexer 100.

The counter 200, in the embodiment shown in FIG. 1, includes a plurality of counter outputs 210 and a single counter input 230. The counter outputs 210 and the single counter input 230 can be electrical pins, electrical pads, or any other conductive elements of the counter 200. The counter 200 in the embodiment of FIG. 1 is a binary counter that, as would be understood by one with ordinary skill in the art, includes a series of flip-flops that receive a digital pulse stream at the counter input 230 and output a plurality of binary counter signals 220 representing the digital pulse stream at the counter outputs 210. The number of counter outputs 210 is equal to the number of control inputs 140 and each of the counter outputs 210 is connected to one of the control inputs 140. The binary counter signals 220 transmitted along the counter outputs 210 include a first counter signal 222, a second counter signal 224, and a third counter signal 226 in the shown embodiment.

In the embodiment shown in FIG. 1, the ECU 300 has a single input pin 310, also referred to herein as a first pin 310, and a digital input/output pin 350, also referred to herein as a second pin 350. The ECU 300 includes an analog to digital converter (ADC) 320, a processor 330 connected to the ADC 320, and a memory 340 connected to the processor 330. The ADC 320 may be any type of electronic ADC commonly used in control unit applications. The memory 340 is a non-transitory computer-readable medium, such as RAM or ROM, storing program instructions or algorithms thereon that, when executed by the processor 330, perform the functions of the processor 330 or the ECU 300 described in detail below. The memory 340 also stores sensing data 341 of the sensing assembly 10. The processor 330 is connected to the second pin 350 and can output signals from the ECU 300 through the second pin 350. The first pin 310 is connected to the multiplexer output channel 170 and the second pin 350 is connected to the single counter input 230; each are connected, for example, by an electrical conductor or any other electrical element capable of transmitting an electrical signal.

The sensors 400, in the shown embodiment, are each elements that produce a variable resistance in proportion to a change in a sensed temperature. The sensors 400 are each a thermocouple or a thermistor, such as a Pt1000 sensor, a Negative Temperature Coefficient (NTC) thermistor, a Positive Temperature Coefficient (PTC) thermistor, or a Resistance Temperature Detector (RTD). The sensors 400, as shown in FIG. 1, are each connected to one of the sensor input channels 130 of the multiplexer 100. In the shown embodiment, the sensors 400 include a first sensor 401, a second sensor 402, a third sensor 403, a fourth sensor 404, and a fifth sensor 405, and there are correspondingly five sensor input channels 130 in the multiplexer 100. In other embodiments, the sensors 400 may include less than five sensors or, with a larger number of input channels 110 in the multiplexer 100, could include six or more sensors.

The framing devices 500 are each an element that produces a signal representative of a known fixed resistance. In an embodiment, each of the framing devices 500 is a resistor. The framing devices 500, as shown in FIG. 1, are each connected to one of the framing input channels 120 of the multiplexer 100. In the shown embodiment, the framing devices 500 include a first framing device 501, a second framing device 502, and a third framing device 503, and there are correspondingly three framing input channels 120 in the multiplexer 100. In other embodiments, the framing devices 500 may include two or four or more framing devices, with a corresponding number of framing input channels 120.

The voltage source 700, shown in FIG. 1, is connected to the sensors 400 and the framing devices 500 and provides a current to each of the sensors 400 and the framing devices 500. In an embodiment, the voltage source 700 is a separate element such as a battery that, in an exemplary application, is part of a vehicle in which the sensing assembly 10 is installed. In another embodiment, the ECU 300 can serve as the voltage source 600 in lieu of the separate voltage source 700, and the ECU 300 can feed current through the multiplexer 100 to the sensors 400 and the framing devices 500.

The current provided by the voltage source 700 allows each of the sensors 400 and the framing devices 500 to output a series of individual values 600 to the respective input channels 110 of the multiplexer 100 representative of resistance. As shown in FIG. 1, the first framing device 501 outputs a first framing start value 612, the second framing device 502 outputs a second framing start value 614, and the third framing device 503 outputs a framing end value 632. The first framing start value 612, the second framing start value 614, and the framing end value 632 are each a signal representative of a known fixed resistance of the respective framing device 501-503. The first sensor 401 outputs a first sensor value 621, the second sensor 402 outputs a second sensor value 622, the third sensor 403 outputs a third sensor value 623, the fourth sensor 404 outputs a fourth sensor value 624, and the fifth sensor 405 outputs a fifth sensor value 625. Each of the sensor values 621-625, in the shown embodiment, is a signal representative of a variable resistance that depends on the temperature sensed by the respective sensor 401-405.

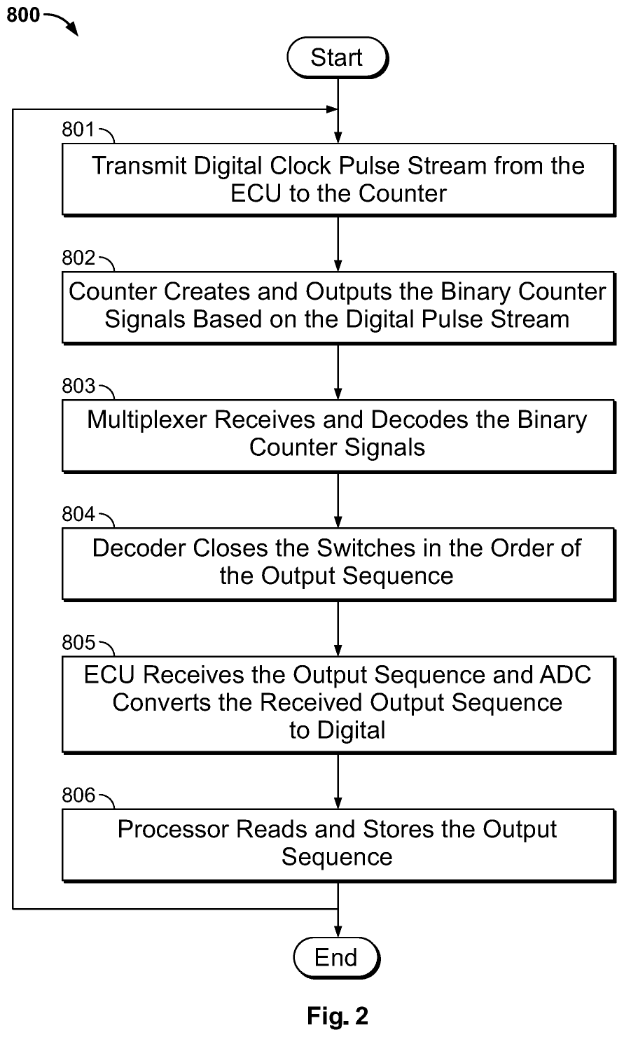

A process 800 of using the sensing assembly 10 to transmit data from the plurality of sensors 400 to the ECU 300 is shown in FIG. 2.

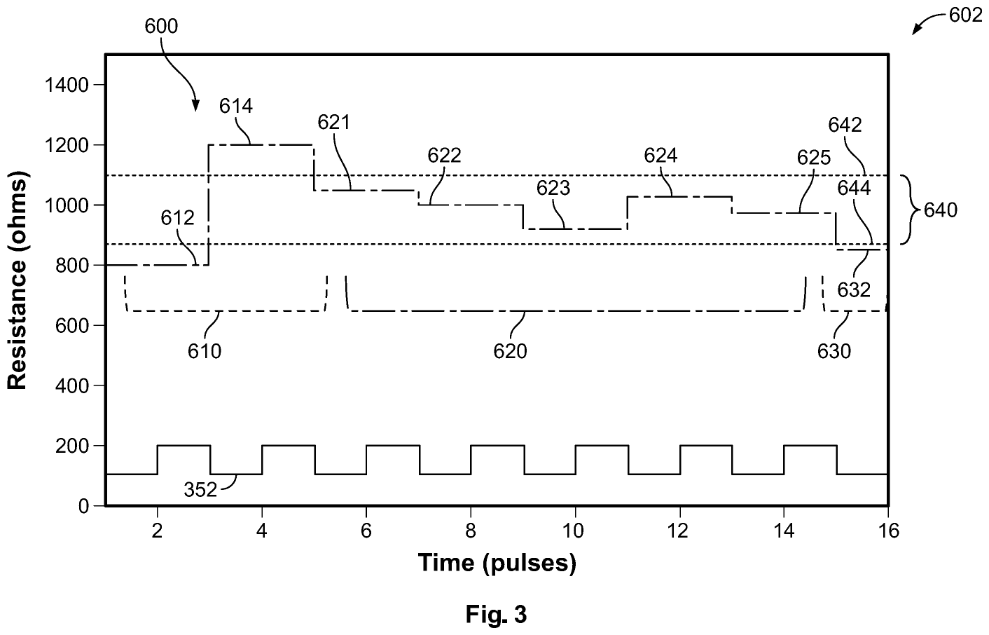

In a step 801 shown in FIG. 2, the processor 330 executes a data gathering algorithm 342 stored on the memory 340 to transmit a digital clock pulse stream 352, shown in FIG. 1, through the digital input-output pin 350 and to the single counter input 230 of the counter 200. The digital clock pulse stream 352 represents an output sequence 602 of the individual values 600 of the sensors 400 and the framing devices 500 to be transmitted along the multiplexer output channel 170 to the ECU 300. An exemplary output sequence 602 is shown in the graph of FIG. 3 and will be described in greater detail following the description of the process 800.

In a step 802 shown in FIG. 2, the counter 200 receives the digital pulse stream 352 and creates the binary counter signals 220, including the first counter signal 222, the second counter signal 224, and the third counter signal 226 shown in FIG. 1, that represent the output sequence 602 of the values 600 received in the digital pulse stream 352. The counter 200 outputs the binary counter signals 220 at the counter outputs 210.

The multiplexer 100, in a step 803 shown in FIG. 2, receives the binary counter signals 220 at the control inputs 140. The decoder 150 connected to the control inputs 140 decodes the binary counter signals 220 and determines the sequence of closure of the switches 160 that is necessary to create the output sequence 602 of the values 600.

The decoder 150, in a step 804 shown in FIG. 2, controls the switches 160 to close and open in the order determined by the decoding of the binary counter signals 220. For example, the decoder 150 first closes the first switch 161 to transmit the first framing start value 612 at the multiplexer output channel 170 as the first value of the output sequence 602, then closes the second switch 162 to transmit the second framing start value 614 at the multiplexer output channel 170 as the second value of the output sequence, sequentially moving through the switches 161-168 to create the output sequence 602 transmitted at the multiplexer output channel 170 as a successive and ordered transmission of each of the sensor values 621-625 between the framing start values 612, 614 and the framing end value 632.

The ECU 300 receives the output sequence 602 of the series of individual values 600 transmitted through the single multiplexer output channel 170 at the single input pin 310, in a step 805 shown in FIG. 2. The individual values 600 in the output sequence 602 are analog signals when they are received at the input pin 310. The ADC 320 converts the individual values 600 from analog to digital values before passing the digital output sequence 602 to the processor 330.

The processor 330, in a step 806 shown in FIG. 2, executes a data storing algorithm 344 stored on the memory 340 to read the value 600 of the output sequence 602 and store the value 600 in the output sequence 602, shown in an exemplary embodiment in FIG. 3, in the sensing data 341 of the memory 340.

The steps 801-806 occur sequentially for each entry in the output sequence 602 and, in an embodiment, the processor 330 waits a short settling time between the closure of the one of the switches 160 in step 804 and the converting and reading of the one of the values 600 into the output sequence 602 in steps 805 and 806, prior to continuing the digital pulse stream 352 in step 801 for the next value 600 in the output sequence 602. The process 800 continuously loops through the steps 801-806, creating multiple output sequences 602, until the current is no longer supplied by the voltage source 700 or the ECU 300 is otherwise deactivated.

The output sequence 602 read by the processor 330 and stored in the sensing data 341 of the memory 340 is shown in an exemplary graph form in FIG. 3. FIG. 3 shows the change in resistance in the values 600 read in the output sequence 602 over the series of pulses from the digital clock pulse stream 352 originally transmitted from the ECU 300. The digital clock pulse stream 352 is shown schematically in FIG. 3 and not in units of resistance.

As shown in FIG. 3, the values 600 of the output sequence 602 are stored with a predetermined sensor value range 640 in the sensing data 341 of the memory 340. The predetermined sensor value range 640 is in units of resistance, the same units as the values 600, and has a higher bound 642 and a lower bound 644. Values within the predetermined sensor value range 640 are valid values for the outputs of the sensors 400; resistance values output by the sensors 400 within the predetermined sensor value range 640 are within a feasible range and indicate the sensor 400 is likely functioning. Values higher than the higher bound 642 or lower than the lower bound 644 are outside a feasible range of outputs for the sensors 400 and indicate the sensor 400 is likely malfunctioning. In the shown embodiment, the higher bound 642 is a resistance of approximately 1100 Ohms and the lower bound 644 is a resistance of approximately 900 Ohms.

In the embodiment of the output sequence 602 described in detail herein and shown in FIG. 3, the first framing start value 612 and the second framing start value 614 different from the first framing start value 612 are part of a framing start segment 610 at the beginning of the output sequence 602. The framing start segment 610 precedes a plurality of sensor values 620 in the output sequence 602. The first framing start value 612 and the second framing start value 614 are both outside of the predetermined sensor value range 640. In the shown embodiment, the first framing start value 612 is less than the lower bound 644 and the second framing start value 614 is higher than the higher bound 642. In another embodiment, the first framing start value 612 could be higher than the higher bound 642 and the second framing start value 614 could be less than the lower bound 644. In another embodiment, the framing start segment 610 may only have one of the first framing start value 612 and the second framing start value 614, and may be higher than the higher bound 642 or less than the lower bound 644.

As shown in FIG. 3, the sensor values 620 including the values 621-625 follow the framing start segment 610 in the output sequence 602. The sensor values 620 are within the predetermined sensor value range 640 if the sensor values 620 are valid and, in the present embodiment, represent a temperature detected by each of the sensors 400.

A framing end segment 630 follows the sensor values 620 and ends the output sequence 602, as shown in FIG. 3. In the shown embodiment, the framing end segment 630 includes the framing end value 632, which is less than the lower bound 644 of the predetermined sensor value range 640. In other embodiments, the framing end value 632 may be higher than the higher bound 642. In other embodiment, the framing end segment 630 may have more than one framing end value 632, provided each of the framing end values 632 are different from one another and outside of the predetermined sensor value range 640. The framing end value 632 is different from each of the first framing start value 612 and the second framing start value 614.

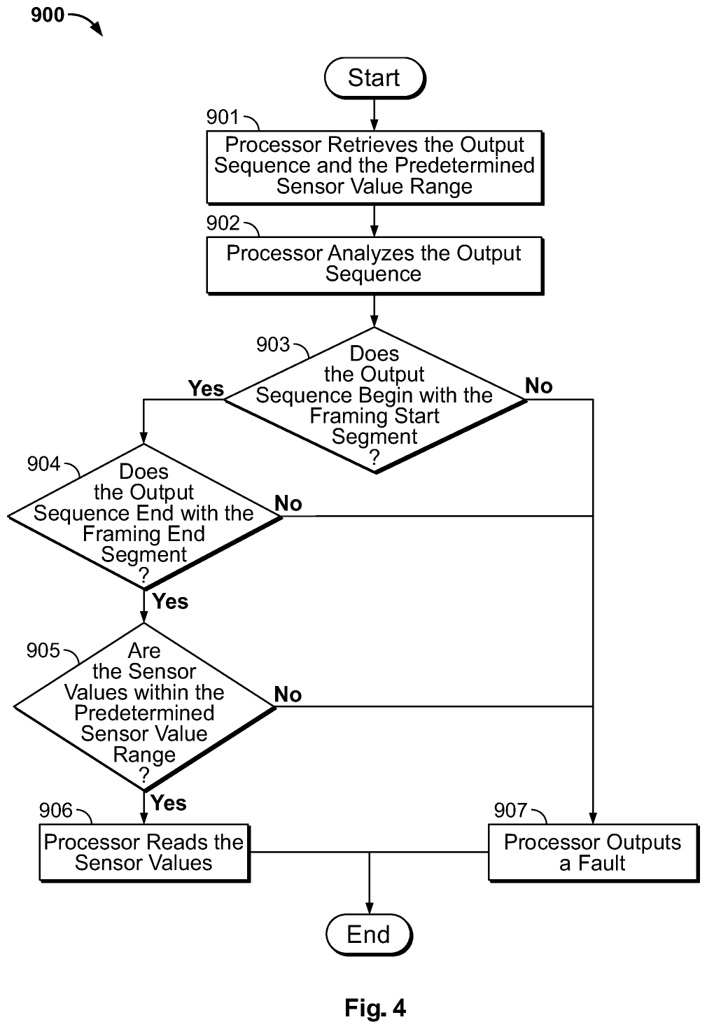

A fault checking process 900 of using the sensing assembly 10 to determine a fault in at least one of the sensors 400 of the sensing assembly 10 through analysis of the output sequence 602 is shown in FIG. 4. The steps of the fault checking process 900 described herein and shown in FIG. 4 are performed by the processor 330 executing a fault algorithm 346, shown in FIG. 1, stored on the memory 340.

In a step 901 shown in FIG. 4, the processor 330 retrieves the output sequence 602 and the predetermined sensor value range 640 stored in the sensing data 341. In a step 902 shown in FIG. 4, the processor 330 analyzes the output sequence 602 to determine which values 600 of the output sequence 602 are outside of the predetermined sensor value range 640 and which values 600 of the output sequence 602 are within the predetermined sensor value range 640.

The processor 330 determines whether the output sequence 602 begins with the framing start segment 610 outside of the predetermined sensor value range 640. In a step 903, if the output sequence 602 does not begin with the first framing start value 612 and the second framing start value 614 outside of the predetermined sensor value range 640, the processor 330 determines that the sensing assembly 10 has malfunctioned and outputs a fault in a step 907. If the processor 330 determines in the step 903 that the output sequence 602 begins with the framing start segment 610 including the first framing start value 612 and the second framing start value 614, the processor 330 continues to a step 904. As described above, the framing start segment 610 may contain a different quantity and different values of the framing start values 612, 614 outside of the predetermined sensor value range 640, and the processor 330 in the step 903 compares the intended framing start segment 610 of the embodiment to the output sequence 602 to determine whether a fault has occurred.

In the step 904 shown in FIG. 4, the processor 330 determines whether the output sequence 602 ends with the framing end segment 630 outside of the predetermined sensor value range 640. If the output sequence 602 does not end with the framing end value 632 outside of the predetermined sensor value range 640, the processor 330 determines that the sensing assembly 10 has malfunctioned and outputs a fault in a step 907. If the processor 330 determines in the step 904 that the output sequence 602 ends with the framing end value 632 of the framing end segment 630, the processor 330 continues to a step 905. As described above, the framing end segment 630 may contain a different quantity and different values of the framing end value 632 outside of the predetermined sensor value range 640, and the processor 330 in the step 904 compares the intended framing end segment 630 of the embodiment to the output sequence 602 to determine whether a fault has occurred.

If the processor 330 determines that the framing start segment 610 and the framing end segment 630 outside of the predetermined sensor value range 640 properly begin and end the output sequence 602, the processor 330 analyzes the sensor values 620 in the step 905. If all the sensor values 620 are within the predetermined sensor value range 640, the processor 330 proceeds to a step 906. If any of the sensor values 620 are outside of the predetermined sensor value range 640, the processor 330 determines a malfunction in the sensor 400 corresponding to the sensor value 620 and outputs a fault in step 907.

In the step 906 shown in FIG. 4, the processor 330 has determined that the output sequence 602 properly reflects the read sensor values 620 and that no faults have occurred in the sensing assembly 10. In this step 906, the processor 330 executes an algorithm stored on the memory 340 to determine a temperature detected by each of the sensors 400 based on the read resistances of the sensor values 620.

In an exemplary embodiment, the sensors 400 are installed adjacent to contact pins and sense a temperature of the contact pins. For example, in an electrical vehicle application, the sensors 400 can be used to detect the temperature of contact pins in a charging receptacle of the vehicle to prevent overheating. In this embodiment, a pair of sensors 401-404 can be disposed next to one DC contact pin; the shown embodiment has two pairs of sensors 401-404 for two DC contact pins. In the shown embodiment, the fifth sensor 405 can be used, for example, to detect the temperature of an AC contact pin. In another embodiment, the fifth sensor 405 can be omitted. In this application, as any fault in the sensing assembly 10 including the plurality of sensors 400 can be detected through analysis of the output sequence 602, the sensing assembly 10 can be used to meet Automotive Safety Integrity Level C compliance while only using the single input pin 310 of the ECU 300.

The application of the sensing assembly 10 in detecting the temperature of contact pins of an electric or hybrid vehicle, however, is only one possible embodiment. The sensing assembly 10 is generally applicable in any application in which a plurality of sensor values must be sent along a number of channels that is less than the number of sensor values, i.e. sent along the single multiplexer output channel 170 to the single input pin 310 of the ECU 300, without compromising the detection of faults or malfunctions in the sensors 400 and the sensing assembly 10. In another embodiment, for example, the sensors 400 can detect whether a door of a vehicle charging inlet is open and the multiplexer can transmit the sensor values along the single multiplexer output channel 170 to the single input pin 310 of the ECU 300 for fault detection using the framing segments 610, 630 and the predetermined sensor value range 640. The sensing assembly 10 allows for a large number of values 600 from sensors 400 to be accurately read, and faults accurately determined, without requiring an expensive control unit having numerous pins or requiring re-design and re-tooling of structural elements of the application to accommodate a different control unit.

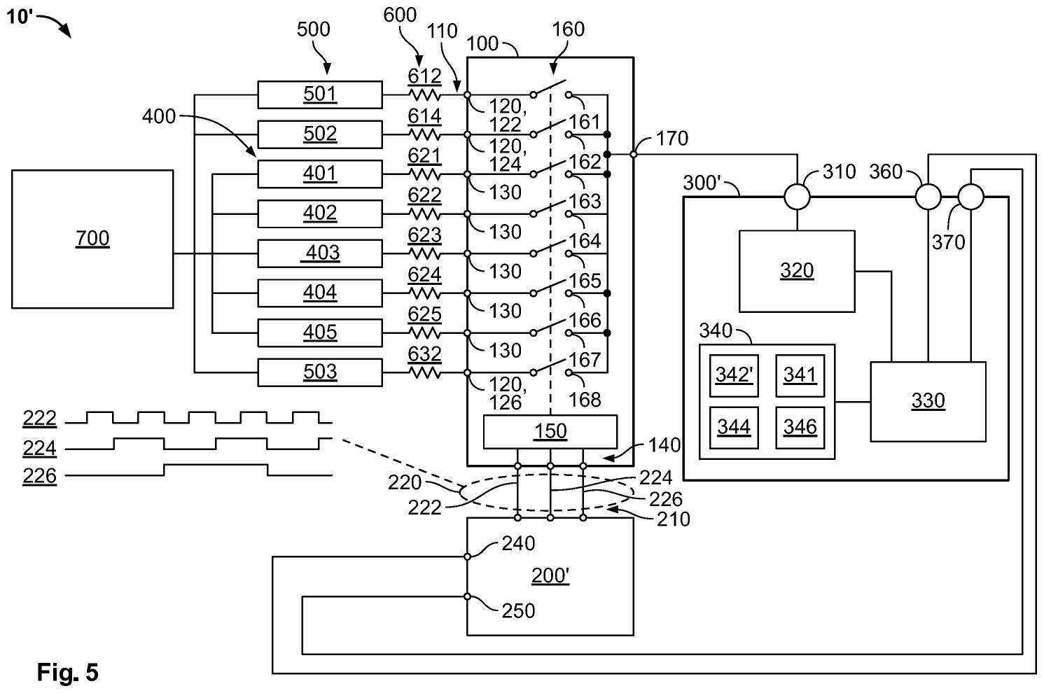

A sensing assembly 10′ according to another embodiment is shown in FIG. 5. Like reference numbers indicate like elements with respect to the embodiments of the sensing assembly 10 described with respect to FIG. 1-4 above, and primarily the differences of the embodiment of FIG. 5 will be described in detail.

A counter 200′ and an ECU 300′ of the sensing assembly 10′ differ from the counter 200 and ECU 300 of the sensing assembly 10. The counter 200′ of the sensing assembly 10′, instead of the single counter input 230 in the embodiment of FIG. 1, has a bidirectional data input 240 and a clock input 250 separate from the bidirectional data input 240, as shown in FIG. 5. The counter 200′, in an embodiment, is an I2C counter, for example an I2C I/O expander. The counter 200′ embodied as an I2C counter provides inherent noise immunity and permits the ECU 300′ to be positioned further, for example approximately two meters in certain applications, from the counter 200′ and the multiplexer 100.

The ECU 300′, instead of a single digital input/output pin 350 in the embodiment of FIG. 1, has a data input/output pin 360 and a clock pin 370 separate from the data input/output pin 360, as shown in FIG. 5. In addition to the input pin 310 described above also referred to as the first pin 310, the data input/output pin 360 can be referred to as a second pin 360 and the clock pin 370 can be referred to as a third pin 370 of the ECU 300′. The second pin 360 of the ECU 300′ is connected to the bidirectional data input 240 of the counter 200′ and the third pin 370 of the ECU 300′ is connected to the clock input 250 of the counter 200′; each are connected, for example, by an electrical conductor or any other electrical element capable of transmitting an electrical signal. The processor 330 has bidirectional data communication with the counter 200′ through the second pin 360 and the bidirectional data input 240.

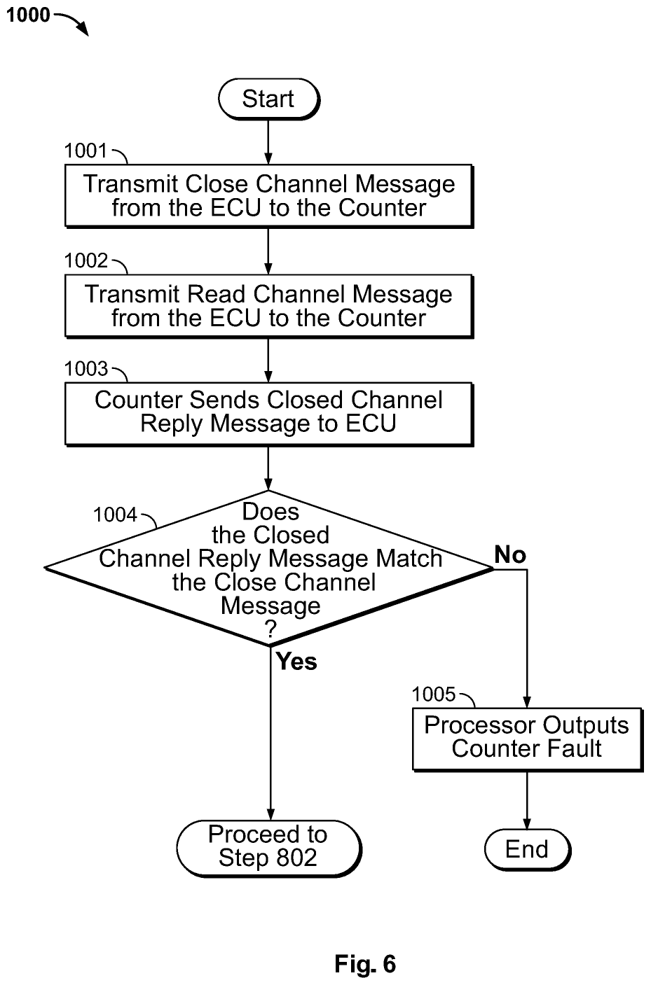

A beginning of a process 1000 of using the sensing assembly 10′ to transmit data from the plurality of sensors 400 to the ECU 300′ is shown in FIG. 6. The process 1000 includes determination of a counter fault in the counter 200′. Primarily the differences from the process 800 will be described in detail in the process 1000; the process 1000 details steps that occur in lieu of the step 801 in the process 800 shown in FIG. 2.

In a step 1001 shown in FIG. 6, the processor 330 executes a data gathering algorithm 342′ stored on the memory 340 to send a close channel message through the data input/output pin 360 and to the bidirectional data input 240 of the counter 200′. The close channel message corresponds to one of the plurality of input channels 110 and represents a corresponding switch 160 in the multiplexer 100 to be closed to create the output sequence 602.

The processor 330, in a step 1002 shown in FIG. 6, transmits a read channel message through the data input/output pin 360 and to the bidirectional data input 240 of the counter 200′. The read channel message requests a response from the counter 200′ on which of the input channels 110 the counter 200′ has sent a signal to the multiplexer 100 to read based on the close channel message. The counter 200′ replies with a closed channel reply message through the bidirectional data input 240 and to the data input/output pin 360 of the ECU 300′ in a step 1003, reflecting an actual channel of the input channels 110 that was closed.

In a step 1004 shown in FIG. 6, the processor 330 compares the close channel message to the closed channel reply message. If the one of the input channels 110 in the close channel message is not the same as the one of the input channels 110 in the closed channel reply message, the processor 330 determines that the counter 200′ has malfunctioned and outputs a counter fault in a step 1005.

If the close channel message matches the closed channel reply message in the step 1004, the processor 330 determines that the counter 200′ and the transmission lines between the ECU 300′ and the counter 200′ are functioning properly. In this case, the sensing assembly 10′ proceeds to create the output sequence 602 similarly to the process 800 shown in FIG. 2; the counter 200′ outputs the binary control signals 220 based on the close channel messages transmitted from the ECU 300′ through the data input/output pin 360 to the bidirectional data input 240 of the counter 200 and clock signals transmitted from the ECU 300′ through the clock pin 370 to the clock input 250 of the counter 200′. The output sequence 602 is then created, read, and stored as shown in steps 803-806 in FIG. 2 and described in detail above. The processor 330 can perform the fault detection of the counter 200′ in the process 1000 for each close channel message used to create the output sequence 602, for the first close channel message of each output sequence 602, or with any other frequency. In another embodiment, the fault detection of the counter 200′ in steps 1002-1005 can be omitted. Following the creation of the output sequence 602, the sensing assembly 10′ can check the output sequence 602 for faults in the sensors 400 and the sensing assembly 10′ as described with respect to FIGS. 3 and 4 above.

What is claimed is:

1. A sensing assembly, comprising:
a plurality of sensors; and
a multiplexer having a plurality of input channels and a multiplexer output channel, the plurality of input channels include a plurality of sensor input channels each connected to one of the sensors and a plurality of framing input channels, the multiplexer outputs an output sequence of a series of individual values received at the input channels at the multiplexer output channel, the output sequence has a plurality of sensor values received from the sensors between a framing start value and a framing end value received at the framing input channels.

2. The sensing assembly of claim 1, further comprising a counter having a plurality of counter outputs connected to a plurality of control inputs of the multiplexer, the counter dictating the output sequence with a plurality of counter signals transmitted from the counter to the multiplexer.

3. The sensing assembly of claim 2, wherein the counter has a single counter input.

4. The sensing assembly of claim 2, wherein the counter has a bidirectional data input and a clock input separate from the bidirectional data input.

5. The sensing assembly of claim 1, wherein the framing start value and the framing end value are outside of a predetermined sensor value range that corresponds to valid sensor values.

6. The sensing assembly of claim 5, wherein the framing start value is a first framing start value of a framing start segment that precedes the sensor values in the output sequence, the framing start segment includes the first framing start value and a second framing start value different from the first framing start value.

7. The sensing assembly of claim 6, wherein one of the first framing start value and the second framing start value is less than a lower bound of the predetermined sensor value range and the other of the first framing start value and the second framing start value is higher than a higher bound of the predetermined sensor value range.

8. The sensing assembly of claim 1, wherein the sensor values, the framing start value, and the framing end value are each a resistance value.

9. The sensing assembly of claim 5, further comprising an electronic control unit having a single input pin connected to the multiplexer output channel and receiving the output sequence.

10. The sensing assembly of claim 9, wherein the electronic control unit has a memory and a processor executing a fault algorithm stored on the memory to determine a fault in the sensing assembly through analysis of the output sequence.

11. The sensing assembly of claim 10, wherein the processor determines the fault if the output sequence does not have one of the framing start value and the framing end value or the processor determines the fault if any of the sensor values are outside of the predetermined sensor value range.

12. The sensing assembly of claim 9, further comprising a counter connected to the multiplexer and dictating the output sequence, the single input pin of the electronic control unit is a first pin and the electronic control unit has a second pin connected to the counter, the electronic control unit controls the counter through the second pin.

13. The sensing assembly of claim 12, wherein the electronic control unit has a third pin connected to the counter, the electronic control unit has bidirectional data communication with the counter through the second pin and transmits a clock signal to the counter through the third pin.

14. A method of transmitting data from a plurality of sensors, comprising:
providing a sensor assembly including the plurality of sensors and a multiplexer having a plurality of input channels and a multiplexer output channel, the plurality of input channels include a plurality of sensor input channels each connected to one of the sensors and a plurality of framing input channels; and
outputting an output sequence of a series of individual values received at the input channels at the multiplexer output channel, the output sequence has a plurality of sensor values received from the sensors between a framing start value and a framing end value received at the framing input channels.

15. The method of claim 14, wherein the framing start value and the framing end value are outside of a predetermined sensor value range that corresponds to valid sensor values.

16. The method of claim 15, further comprising determining a fault if the output sequence does not have one of the framing start value and the framing end value.

17. The method of claim 15, further comprising determining a fault if any of the sensor values are outside of the predetermined sensor value range.

18. The method of claim 14, further comprising dictating the output sequence with a counter connected to the multiplexer.

19. The method of claim 18, further comprising providing an electronic control unit having a single input pin connected to the multiplexer output channel, the electronic control unit has a second pin connected to the counter through which the electronic control unit controls the counter.

20. The method of claim 19, wherein the electronic control unit has bidirectional data communication with the counter through the second pin, and further comprising the steps of:
sending a close channel message corresponding to one of the plurality of input channels from the electronic control unit to the counter;
sending a read channel message from the electronic control unit to the counter, the counter sending a closed channel reply message to the electronic control unit in response to the read channel message, the closed channel reply message reflecting an actual channel of the plurality of input channels that was closed; and
determining a fault in the counter if the one of the input channels in the closed channel reply message is not the same as the one of the input channels in the close channel message.
